(19) United States
(12) Patent Application Publication
(10) Pub. No.: US 2014/0320368 A1
(43) Pub. Date: Oct. 30, 2014

(54) ANTENNA WITH PLANAR LOOP ELEMENT

(71) Applicant: Jeffrey Thomas Hubbard, PHOENIX, AZ (US)

(72) Inventor: Jeffrey Thomas Hubbard, PHOENIX, AZ (US)

(21) Appl. No.: 14/261,396

(22) Filed: Apr. 24, 2014

Related U.S. Application Data
(60) Provisional application No. 61/815,297, filed on Apr. 24, 2013.

(51) Int. Cl. H01Q 5/00; H01Q 7/00

(52) U.S. Cl. CPC H01Q 5/0062; H01Q 7/00
USPC 343/834; 343/866

(57) ABSTRACT

An antenna for wideband operation comprises a planar loop element having a total-length-to-width ratio below about 50:1. In one embodiment, a plurality of planar loop elements are arranged in a Yagi array having a single active element. The dimensions of the elements are chosen to achieve substantially resistive impedance over greater than a thirty percent bandwidth and a minimum gain of 6.5 dB over isotropic response.

### REFERENCE TO COMPUTER PROGRAM LISTING APPENDIX

The computer program listings electronically submitted as ASCII text files having the names UHF_ANTENNA.TXT and WIFI_ANTENNA.TXT are incorporated herein by reference.

### TECHNICAL FIELD

The invention relates to antennas, and in particular to wideband antennas, including Yagi array antennas.

### BACKGROUND ART

Antennas for wideband operation are highly desired for wireless digital data transmission in industries such as mobile telephone and computer networking. Most advances in this area have centered around microstrip arrays, since these arrays can be readily fabricated for microwave frequencies using well-established methods for making printed circuit boards. Most of these arrays have elements with rectangular or other solid geometrical shapes arranged in a coplanar array.

U.S. Pat. No. 5,510,803 issued to Ishizaka et al. teaches a microstrip array having dual- polarization properties. Patch elements are located in a coplanar array, and the elements are fed through slots from a feed patch located on the other side of the slot. The structure allows switching polarization to either horizontal or vertical mode.

While microstrip designs for microwave operation have many desirable features, these arrays in general are bulky and unwieldy when used at lower frequencies. In addition, the use of a number of solid patch element arranged in a coplanar configuration would present a large wind load, requiring additional mechanical reinforcement far beyond that required for electrical operation.

At lower frequencies, Yagi antennas are a popular thin wire array, due to their high gain relative to array length and their ease of construction. Yagis typically trade bandwidth for gain however, and are usually designed for a single operating frequency. Thus, antennas for wideband operation, e.g. for television or FM band reception, usually are log periodic dipole arrays.

U.S. Pat. No. 6,593,866 issued to Schantz teaches the use of a planar loop for impulse radio communications. It teaches a circular or teardrop-shaped loop, with an outer edge having a length related to the longest wavelength handled by the device and an inner edge related to the shortest wavelength handled by the device, although the exact relationship is not disclosed. More importantly, the mean circumferential length (i.e. the length of a line located midway between inner and outer edges) of the radiating element is equal to one-half the center wavelength of the range of signals “efficiently” handled by the device. The antenna portion is therefore operated as an electrically short loop antenna; this is confirmed by further teaching in Schantz showing that the device radiates mainly in the plane of the loop, rather than transverse to it as in a full wavelength, resonant loop antenna.

A need remained for an antenna array for wideband operation that provides good gain and radiation characteristic in a relatively small volume. An antenna that is simple to construct and has simple feed requirements is also desired. As always, an antenna having substantially constant impedance and radiation characteristics over the entire operating bandwidth is also desirable.

### SUMMARY OF INVENTION

The desired characteristics are accomplished by an antenna comprising a substantially planar loop active element. A gap is defined in one of the sides for connecting means for transmitting or receiving a signal. Some of the loop dimensions used for design are its total outer length and the width of a side of the loop. The ratio of the total outer length of the loop to the width of the loop can be selected to obtain a range of frequencies over which the phase angle of the element is substantially constant; the gap can then be adjusted so that the phase angle is essentially zero. Therefore, the impedance of the antenna in the range of frequencies is essentially resistive. Other combinations of element total outer length, width, and gap can be selected for other operational modes.

Another embodiment having higher gain uses the active element in combination with at least one parasitic element. The element are arranged as in a conventional Yagi array, with the element planes being transverse to an array axis defined between the active and parasitic elements. Preferably, when a single parasitic element is used, it is arranged as a reflector to the active element. Additional parasitic elements can be used in the array for greater gain.

The reflective parasitic element can be either a solid geometrical shape acting as a reflecting plane or a second substantially planar loop. When the reflector is a solid geometrical shape, it can be substantially planar or it can be curved in a parabolic or semi-spherical shape. Another configuration includes a plurality of secondary plane surfaces adjoining the reflecting plane along it edges, the secondary plane surfaces being angled toward the active element in a pseudo-parabolic shape to focus energy toward the active element.

Antennas made in accordance with the described invention have several advantages. Gain is comparable to a thin-wire Yagi while operating over a much wider range of frequencies. Spacing between elements is usually shorter than for thin-wire Yagis, especially for the lower frequencies, so overall boom length can be unusually small for a given gain relative to other antennas. The array can be designed for a feed impedance that is essentially a pure resistance over a thirty percent bandwidth. Since the elements are loops rather than dipoles, the circuit is completed within the element itself and the antenna therefore enjoys improved resistance to adverse effects of nearby objects (compared to dipole antennas) that is well known for loop antennas. While the front-to-back ratio for the antenna drops rapidly as frequency increases, the radiation pattern of the main lobe is exceptionally stable over the entire frequency band of operation, and there is virtually no formation of multiple secondary lobes in the rear radiation plane. Instead, only a single secondary lobe is generally present, creating a sort of lopsided dumbbell radiation pattern. Other advantages and features of the invention will become apparent in the following description and from the drawings.

### BRIEF DESCRIPTION OF THE DRAWINGS

FIG. 1 is a front plan view of a square planar loop element, noting the important dimensions thereof

FIG. 2 is a graph of the impedance versus frequency behavior of the loop element of FIG. 1 for various ratios of element total outer length to width.

FIG. 3 is a perspective view of a three-element parasitic array antenna according to the invention.

FIG. 4 is a perspective view of an alternative embodiment of the antenna comprising a single square planar loop element and a solid plane reflector.

### DESCRIPTION OF THE PREFERRED EMBODIMENTS

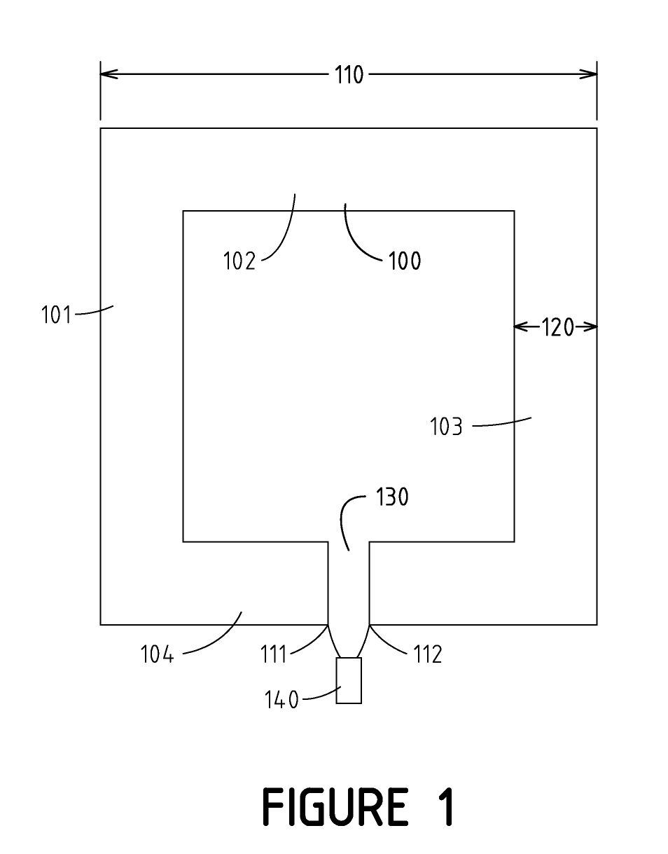

FIG. 1 depicts a basic resonant planar loop element 100. Throughout the following discussion and in the claims, the term “resonant planar loop” is defined as a planar loop wherein the overall length of the loop is comparable to the operating wavelength as opposed to an electrically short loop. As a result, the loop will have its major radiation lobe transverse to the plane of the element and will resonate without the need for impedance matching components, Other shapes besides a square can be used, including but not limited to a circle, triangle, or other regular polyhedron. The four sides 101, 102, 103, and 104 of the element 100 have substantially identical dimensions, but can be of unequal lengths and widths. The dimensions used to design the antenna are the outer length 110 and the width 120. While a uniform width is preferred, small changes can be made in width, especially narrowing of a side in the region around the feed points. The element is thin, i.e. its dimension transverse to the plane of the loop is negligible in comparison to the outer length 110 and the width 120, usually much less than one percent of the outer length 110. A gap 130 is defined in the middle of one side of the loop which provides means for attaching a transmitter or receiver (not shown) via a transmission line or balun 140. As shown, the element has horizontal polarization in the E plane; the gap 130 can be located in another side for vertical polarization or in a corner or other location for a combination of horizontal and vertical polarization.

The various parameters allow adjustment of the element for various modes of operation. A number of different configurations were modeled using NEC2 (Numerical Electromagnetic Code, version 2) method of moments modeling software originally developed at Lawrence Livermore Laboratories in 1981. The planar element was modeled as a square wire mesh following the Equal Area Rule for selecting wire diameter. Symbols were used throughout the input file to allow for quick changes in parameters and to try to keep the wire mesh as square as possible. To simplify the model, the element 100 was connected to the feed line at the lower corners 111 and 112 defined by the bottom side 104 and the gap 130, as shown in FIG. 1. The actual connection points can be located further apart on the bottom side 104 however, preferably equally spaced about the gap 130. In the following discussion, the term “feedpoint gap” is defined as the distance between the two points where the means for attaching a transmitter or receiver connects to the antenna. This term will be used to avoid confusion with the actual width of the mechanical gap 130, although the two can be identical.

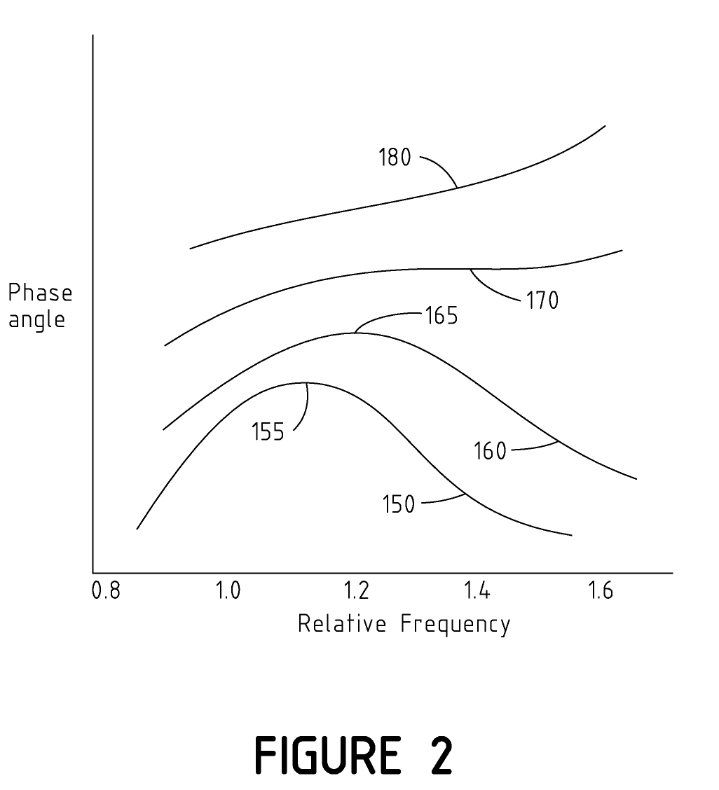

An important configuration parameter is the total-length-to-width ratio, which is defined as the ratio of the sum of the outer lengths 110 for all sides 101, 102, 103, and 104 to the average width of the sides. FIG. 2 schematically depicts how the phase angle of the element impedance changes with frequency for various values of the total-length-to-width ratio. In general, the curves for larger total-length-to-width ratios form a local maximum, depicted by reference numbers 155 and 165 in FIG. 2. For a high total-length-to-width ratio, the phase angle changes quickly with frequency and goes through relatively large swings, as shown in curve 150. As the total-length-to-width ratio is reduced, i.e. as the element becomes ‘fatter,’ both the rate of change and the total swing are also reduced, as shown in curve 160. The slope of the portion of the phase-angle-versus-frequency curve above the local maximum 155, 165 changes more rapidly than for the portion below the local maximum. As the total-length-to-width ratio is reduced further, eventually the slope of the portion of the curve above the local maximum becomes horizontal, and the phase angle becomes almost constant over a range of frequencies making up about a thirty percent bandwidth, as shown by curve 170 of FIG. 2. Reducing the ratio further toward the ultimate limit of 2:1 for a solid square patch element results in a phase angle that tends to rise continuously with frequency as shown in curve 180. The curves correspond to total-length-to-width ratios below about fifty to one, and in particular for total-length-to-width ratios below about thirty to one.

For curve 170, although the phase angle is constant over a wide range, the value of the phase angle is not necessarily zero. To obtain a zero phase angle, the feedpoint gap is adjusted. When a zero phase angle is obtained, the feed impedance will be essentially all resistive without any substantial imaginary component. The value of resistive impedance generally tends to rise with frequency; like the phase angle change, the resistive impedance changes more slowly with frequency when using elements with smaller total-length-to-width ratios.

The behavior of the element represented by curve 170 is desirable for an antenna consisting only of a single element. The elements depicted in curve 150 and 160 are desirable when used as elements in a Yagi array. The slope of the portion of the phase versus frequency above or below the local maximum can be adjusted to compensate for the propagation delay (as a fraction of wavelength) between the elements as the operating frequency changes. Thus, the parasitic elements can be designed to constructively interfere with the active element over a wide range of frequencies rather than just a narrow band around the resonant point, as in a conventional Yagi array.

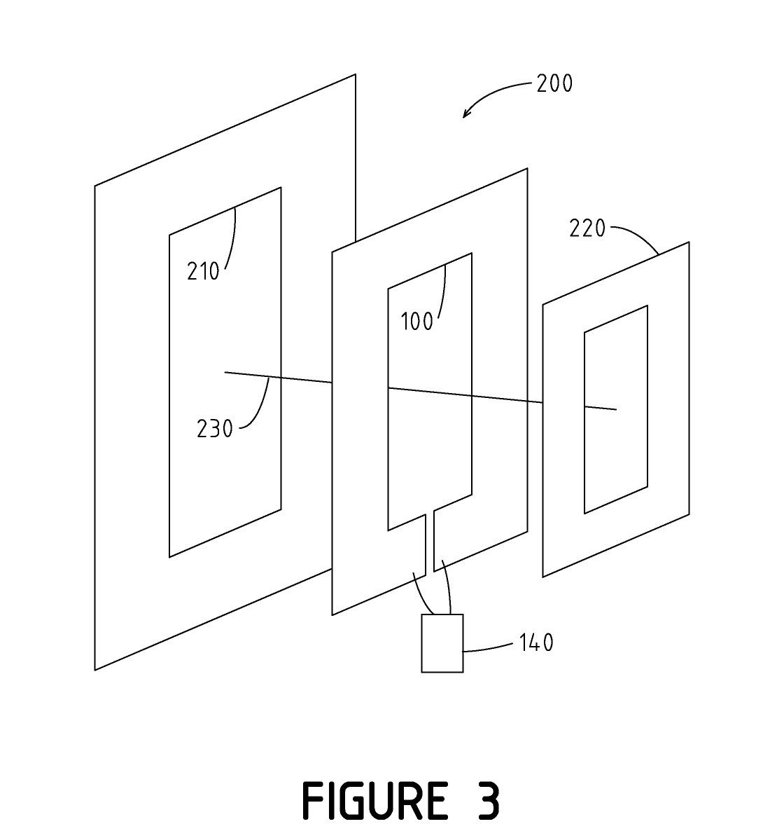

A 3-element array 200 employing the design features just discussed is shown in perspective in FIG. 3. The array 200 has a reflector 210 and a director 220 in addition to the active element 100. The elements are positioned with their centers collinearly aligned along an array axis 230 transverse to the planes of each of the elements. Each element has its own total-length-to-width ratio, which can be selected independently of the other elements. The relative sizes of the elements and their spacing from each other can be selected using well known guidelines for conventional thin-wire Yagi arrays.

An array was constructed as shown in FIG. 3 for use in the UHF television band. The design parameters were determined using the NEC2 modeling software; the input file is appended under the name UHF_ANTENNA.TXT. The active element 100 has a 171 millimeter outer length and a 25 millimeter width, with a 14 millimeter feedpoint gap; the reflector 200 has a 240.8 millimeter outer length and a 32.8 millimeter width; the director 300 has a 98.4 millimeter outer length and a 27.3 millimeter width. Both the reflector-to-active-element spacing and director-to-active-element spacing were 54.7 millimeters. Modeling software predicted a gain of at least 6.5 dB over isotropic and a VSWR of less than 2:1 into a characteristic impedance of 150 ohms from about 470 MHz to 800 MHz. In addition, the imaginary component of the feed impedance was less than one percent of the resistive impedance from 550 MHz to 720 MHz, and was less than ten percent of the resistive impedance from 510 MHz to 756 MHz. While measurement equipment was not available, the array gave comparable performance to a log periodic array with the longest element being 330 millimeters long and an array boom length of about 300 millimeters, more than twice the boom length of the prototype. Other configurations have been constructed, usually having different spacing between the active element and the parasitic elements; as is typical with thin-wire Yagi arrays, the optimal spacing between active element and director is shorter than between active element and reflector. Also, using lower total-length-to-width ratios for the active element result in an array having a lower characteristic impedance. One configuration having an active element width of 36 millimeters for use over the same frequency range had a low enough impedance to couple to a standard 75 ohm input while maintaining a VSWR of less than 2:1 over the operating range.

The Yagi array of FIG. 3 was modified to achieve an operating range over lower frequencies along with higher overall gain. The modified array alignment does not have the essentially resistive performance of the previous alignment, but the reactive component remains less than about 5 percent of the total impedence. In addition, the VSWR feeding into the conventional 75 ohm impedance for a television receiver is appoximately 2.6 over most of the operating range, but can be easily lowered to less than 1.5:1 over the whole operating range with a simple impedance matching filter. In this alignment, the active element 100 has a 180 millimeter outer length and a 32.0 millimeter width, with a 25.0 millimeter feedpoint gap; the reflector 200 has a 241.6 millimeter outer length and a 36.5 millimeter width; the director 300 has a 100.8 millimeter outer length and a 26.0 millimeter width. The reflector-to-active-element spacing is 76.8 mm and the director-to-active-element spacing is 57.6 millimeters. The gain over the frequency range of 470-760 MHz varied from a minimum of about 7.2 dBi to a maximum of about 7.6 dBi.

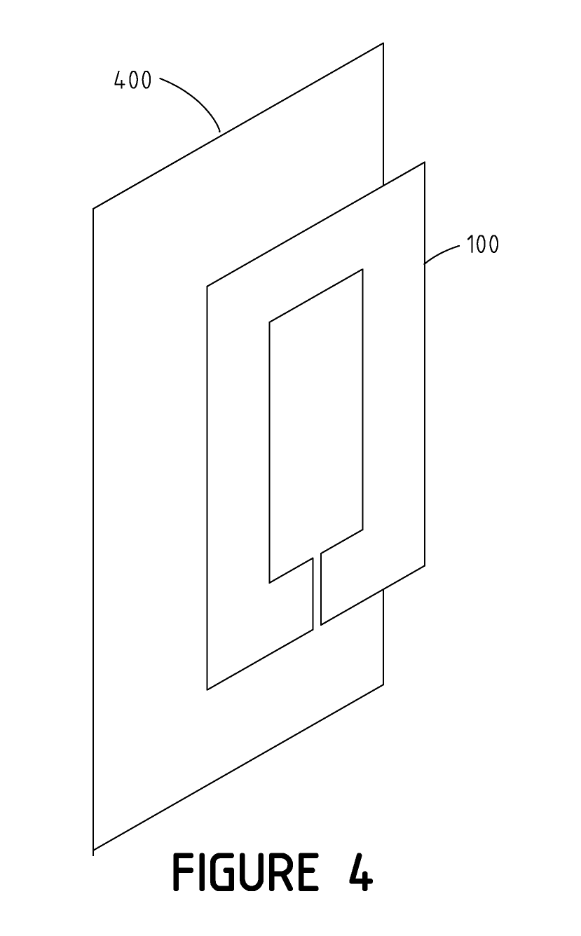

Another embodiment is shown in FIG. 4, where the reflector is replaced with a solid reflecting plane 400. In this case, the change of phase angle with frequency does not change materially with a change in total-length-to-width ratio as in the previous embodiment. However, the total impedance curve versus frequency forms a substantially symmetrical curve having a local minimum (not shown), the value of which is strongly affected by spacing between the active element 100 and the reflecting plane 400. Total-length-to-width ratio, spacing and feedpoint gap can be selected to obtain a characteristic impedance for the antenna spanning a wider range of possible values than for the multi-element array of FIG. 3. Preferably, the parameters are chosen so that the local minimum is located in the center of the desired operating frequency range. The VSWR versus frequency behavior is then substantially symmetrical about the center frequency, although the usable bandwidth is not as wide as the previous embodiment. The rear lobe in the radiation pattern is generally narrower than for the array using all loop elements. Also, a gain of about 8 dB or more can be obtained using just the active element 100 and reflective plane 400.

An antenna in accordance with FIG. 4 was modeled using the NEC2 software; the input file is appended as file WIFI_ANTENNA.TXT. This antenna was designed to cover the 2.39-2.51 GHz band reserved for computer wifi communication with a 50 ohm impedance. The active element 100 has a 36.2 millimeter outer length, a 7 mm width and a 8.8 millimeter feedpoint gap, and is located 17.1 millimeters from the reflective plane 400 which is a square 52.8 millimeters on a side. The antenna had an average gain of just greater than 8 dBi over the operating range. The VSWR is 1.02 at the center frequency of 2450 MHz rising to 1.5 at 2395 MHz and 2508 MHz.

1. An antenna, comprising:
a resonant planar loop active element, having means for connecting the element to a transmitter or receiver, the element having a plurality of sides with length and width dimensions defining a total-length-to-width ratio below about fifty to one.

2. The antenna of claim 1, further comprising at least one parasitic element arranged parallel to the plane of the active element and spaced along an array axis transverse to the active and parasitic element.

3. The antenna of claim 1, wherein the total-length-to-width ratio of the active element is below about thirty to one.

4. The antenna of claim 2, wherein one of the at least one parasitic elements is a reflector, the reflector being either a resonant loop element or a reflecting plane.

5. The antenna of claim 3, further comprising at least one parasitic element arranged parallel to the plane of the active element and spaced along an array axis transverse to the active and parasitic elements.

6. An antenna, comprising:
a thin resonant planar loop active element, having means for connecting the element to a transmitter or receiver, the element having a plurality of sides with length and width dimensions defining a total-length-to-width ratio below about fifty to one;
at least one parasitic element arranged parallel to the plane of the active element and spaced along an array axis transverse to the active and parasitic element.

7. The antenna of claim 6, wherein one of the at least one parasitic elements is a reflector, the reflector being either a resonant loop element or a reflecting plane.
